(19) United States
(12) Patent Application Publication
(10) Pub. No.: US 2023/0321852 A1
(43) Pub. Date: Oct. 12, 2023

(54) Safety Razor, and Connector and Handle for a Safety Razor

(71) Applicant: Edgewell Personal Care Brands, LLC, Chesterfield, MO (US)

(72) Inventors: Nicola Crisp, Hong Kong (HK); Andrew Hitchcock, Bethany, CT (US)

(21) Appl. No.: 18/000,418

(22) PCT Filed: Jun. 10, 2021
(86) PCT No.: PCT/US21/36716

§ 371 Date: Dec. 1, 2022

Related U.S. Application Data
(60) Provisional application No. 63/042,027, filed on Jun. 22, 2020.

(51) Int. Cl. B26B 21/52; B26B 21/22

(52) U.S. Cl. CPC B26B 21/521; B26B 21/522; B26B 21/225

(57) ABSTRACT

A safety razor has a blade unit with a housing and a razor blade, and an elongated handle having a uniform thickness and having a first end including an aperture extending into the thickness, and an opposed second end. The safety razor also has a connector to connect the blade unit to the handle. A body of the connector has a recess with an opening, and a user-operable latch including a protrusion extending into the recess. The first end of the handle is removably received in the recess and the protrusion is received in the aperture to secure the handle to the connector. The protrusion is releasable from the aperture by a user-applied force to a lever at an end of the latch opposite the protrusion end to release the first end of the handle from the recess.

### BACKGROUND

### 1. Technical Field

The present disclosure relates to safety razors in general and, more particularly, to razor cartridge connectors having integral latches, and suitable handles.

### 2. Background

Many modern wet shaving razors, also known as safety razors, typically comprise a handle and a razor cartridge mounted to the handle. Some razors are so-called disposable razors wherein the handle and razor cartridge together are disposed of after use. Other razors may be in the form of a so-called system that comprises a handle that can be reused and a removable razor cartridge that is disposed of after use and can be replaced with a new cartridge. U.S. Pat. No. 5,787,586 discloses an exemplary system razor handle including several component parts that in combination comprise a mechanism to secure and eject a cartridge connector (with its blade unit) of a razor cartridge upon actuation of a release button by a user.

A further type of safety razor is a so-called semi-disposable razor. A simplified handle (in comparison to that in e.g. '586 above), that can be a single component part is provided to a user, together with a small number of replaceable cartridges as a packaged unit, e.g. one handle and five cartridges. The handle is intended to survive a limited number of uses with the supplied cartridges. This combination provides the convenience of a disposable razor but requires less resources, e.g. “less plastic” in comparison to e.g. 5 complete disposable razors. U.S. Pat. No. 6,026,577 discloses an exemplary semi-disposable razor. The handle of this document has attachment structure for the cartridge comprising three prongs, the center of which bears a tooth that snap-fittingly engages the cartridge. The handle of '577 therefore inherently requires certain physical properties, e.g. at least a certain flexural modulus and permissible strain for its center prong to function as disclosed, at least over a requisite limited number of cycles.

### SUMMARY

The present disclosure has for its objective to substantially alleviate the limitations of the prior art razors by providing a safety razor, and a connector and a handle for the same. A safety razor is provided comprising a blade unit having a housing with a razor blade and an elongated handle. The handle has a uniform thickness, preferably 2.7 mm, and has a first end including an aperture extending into the thickness, and an opposed second end. A connector connects the blade unit to the handle. The connector has a body with a first arm and a second arm both extending from the body, respective distal end regions of both arms being adapted to connect the blade unit to the handle. The body has a recess having an opening and a user-operable latch including a protrusion at a first end of the latch, the protrusion extending into the recess. The first end of the handle is removably received in the recess and the protrusion is received in the aperture to secure the connector to the handle, and the protrusion is releasable from the aperture by a user-applied force (F) to a lever at a second end of the latch opposite the first end to release the first end of the handle from the recess.

In some aspects the handle has a curved profile in an orientation perpendicular to the thickness. In some aspects the handle is flat in transverse cross section. In other aspects the handle is not flat, e.g. having a gentle curve in transverse cross section. In some aspects the aperture in the first end of the handle is bounded. In some aspects the aperture in the first end of the handle extends through the first end.

In some aspects the first end of the handle, in combination with the recess of the connector define a poka yoke feature to prevent an incorrect orientation of the handle in the connector. The poka yoke feature can include a first outer corner radius and a second outer corner radius, each outer corner radius being at the first end of the handle, and the first outer corner radius is different than the second outer corner radius, preferably the first outer corner radius has a magnitude three times the magnitude of the second outer corner radius.

In some aspects the handle comprises a plant-based, non-polymeric material, preferably one of wood-based and grass-based, more preferably bamboo. In some aspects the plant-based, non-polymeric material defines a fiber direction. In some aspects the handle comprises a single layer of plant-based non-polymeric material. In other aspects the handle comprises between two and nine layers of plant-based non-polymeric material, preferably three layers of plant-based non-polymeric material. In some aspects of the preceding aspect the fiber direction of any one layer is arranged at an angle to the fiber direction of the next adjacent layer, preferably arranged perpendicularly to the fiber direction of next adjacent layer.

In some aspects the handle comprises only a single component part.

In some aspects the user-operable latch is supported in the body by a torsion beam spring integrally formed between the body and the latch.

In some aspects the connector comprises one of a biopolymer, preferably medium chain polyhydroxyalkanoate (PHA), and mixture of medium chain polyhydroxyalkanoate (PHA) and a plant-based non-polymeric material.

In some aspects of the present disclosure a connector adapted to removably connect a handle to a blade unit is provided. The connector has a body with a first arm and a second arm both extending from the body, respective distal end regions of both arms are adapted to connect the blade unit to the connector. The body has a recess having an opening, and a user-operable latch including a protrusion at a first end of the latch extending into the recess, the recess is adapted to removably receive the first end of the handle, and the protrusion is received in an aperture at the first end, the protrusion being releasable from the aperture by a user-applied force (F) to a lever at a second end of the latch opposite the first end, to release the first end of the handle from the recess.

In some aspects the recess of the connector in combination with the first end of the handle, define a poka yoke feature to prevent an incorrect orientation of the handle when received in the connector. The poka yoke feature can include a first inner corner radius and a second inner corner radius, each inner corner radius being at an end of the recess opposed the opening, and the first inner corner radius is different than the second inner corner radius, preferably the first inner corner radius has a magnitude three times the magnitude of the second inner corner radius. A wall bounding the recess can be provided with a window opening permitting a user to view the inner corner radii.

In some aspects the user-operable latch is supported in the body by a torsion beam spring integrally formed between the body and the latch.

In some aspects the user-operable latch includes a second end opposite the first end and has a lever, and the torsion beam spring is formed with the latch in a region between the first end and the second end.

In some aspects the connector comprises one of a biopolymer, preferably medium chain polyhydroxyalkanoate (PHA), and mixture of medium chain polyhydroxyalkanoate (PHA) and a plant-based non-polymeric material. In other aspects the connector can comprise a thermoplastic polymer, i.e. a petroleum based material.

In some aspects of the present disclosure a handle for a safety razor is provided. The handle comprises an elongated slat having a uniform thickness, preferably 2.7 mm, and having a first end including an aperture extending into the thickness, and an opposed second end. The handle can comprise a plant-based, non-polymeric material that defines a fiber direction, the material being preferably one of wood-based and grass-based, more preferably bamboo.

In some aspects the handle has a curved profile in an orientation perpendicular to the thickness. In some aspects the handle is flat in transverse cross section. In other aspects the handle is not flat, e.g. having a gentle curve in transverse cross section. In some aspects the aperture in the first end of the handle is bounded. In some aspects the aperture in the first end of the handle extends through the first end.

In some aspects the first end of the handle, in combination with a recess of a connector for the safety razor define a poka yoke feature to prevent an incorrect orientation of the handle in the connector. The poka yoke feature can include a first outer corner radius and a second outer corner radius, each outer corner radius being at the first end of the handle, and the first outer corner radius is different than the second outer corner radius, preferably the first outer corner radius has a magnitude three times the magnitude of the second outer corner radius.

In some aspects the handle comprises a single layer of plant-based non-polymeric material. In other aspects the handle comprises between two and nine layers of plant-based non-polymeric material, preferably three layers of plant-based non-polymeric material. In some aspects of the preceding aspect the fiber direction of any one layer is arranged at an angle to the fiber direction of the next adjacent layer, preferably arranged perpendicularly to the fiber direction of the next adjacent layer.

In some aspects the handle comprises only the slat, and the slat is a single component part.

According to the foregoing, a safety razor that can be in the form of a semi-disposable razor is less dependent upon its handle having physical properties at least inherently considered necessary requirements in the prior art. The safety razor can employ “sustainable” and plastics-free materials, especially for its handle.

The above features and advantages will be more fully understood with reference to the following detailed description when taken in conjunction with the accompanying drawings.

### BRIEF DESCRIPTION OF THE DRAWINGS

FIG. 1 is a rear isometric view of a safety razor of the present disclosure;

FIG. 2 is a front isometric view of the safety razor;

FIG. 3 is an upper isometric view of a connector of the present disclosure;

FIG. 4 is a lower isometric view of the connector;

FIG. 5 is a plan view of the connector;

FIG. 6 is an end view of the connector;

FIG. 7 is a sectional view of the connector taken at 7-7 of FIG. 6;

FIG. 8 is an upper isometric view of a handle of the present disclosure;

FIG. 9 is a plan view of the handle;

FIG. 10 is a side view of the handle;

FIG. 11 is a side view of another safety razor;

FIG. 12 is a detailed view of a first end of another handle;

FIG. 13 is a schematic transverse sectional view of a handle;

FIG. 14 is a schematic transverse sectional view of another handle;

FIG. 15 is a transverse sectional view of a handle taken at 15-15 of FIG. 12; and

FIG. 16 is a detailed portion of a sectional view of a connector connected to a handle, taken at a plane similar to that of FIG. 7.

### DETAILED DESCRIPTION

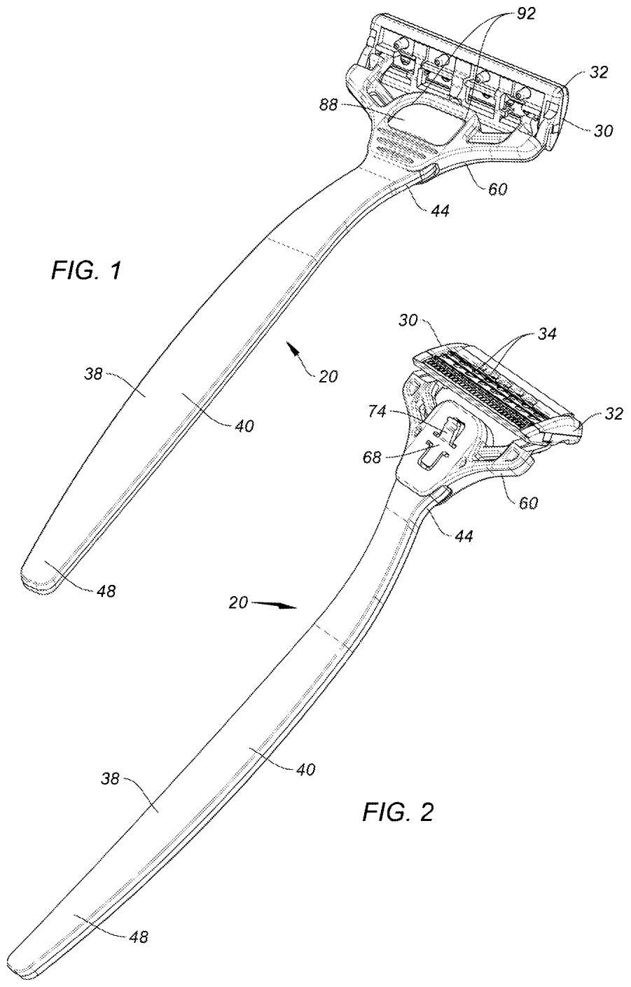

Referring now to the drawings, and in particular FIGS. 1 and 2, a safety razor 20 is depicted. The safety razor 20 comprises a blade unit 30 having a housing 32 with a razor blade 34, an elongated handle 40 and a connector 60 connecting the blade unit 30 to the handle 40. The materials and construction of a blade unit 30 containing one or several blades 34 will be well known to the skilled worker and will not require further discussion.

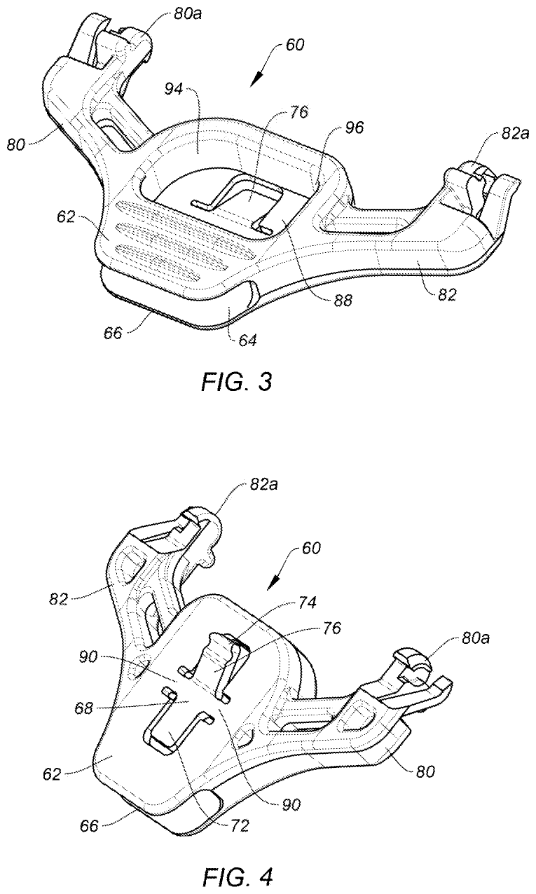

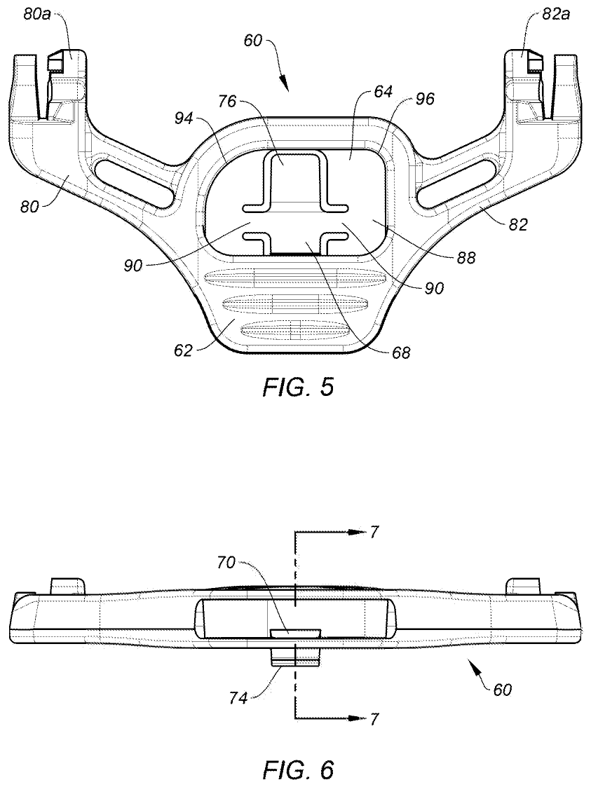

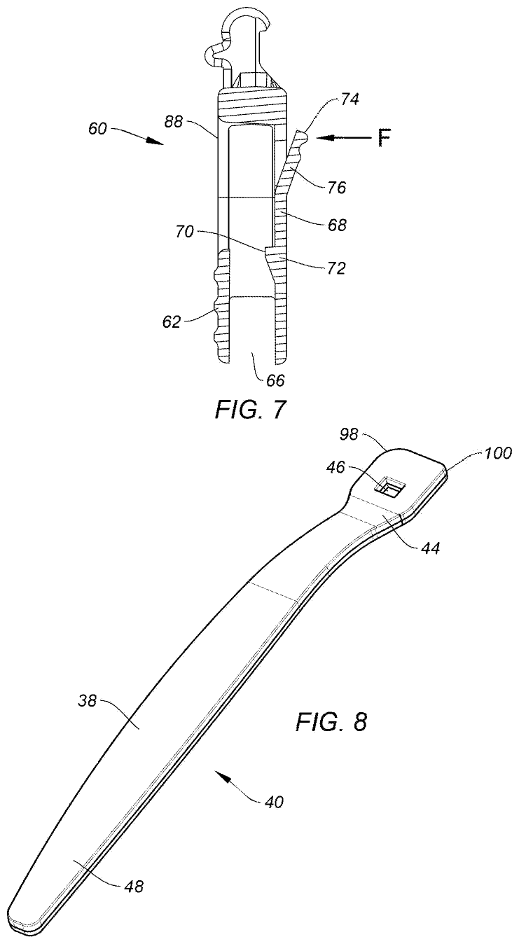

Referring additionally to FIGS. 3-7, a connector 60 is depicted. The connector 60 has a body 62 with a first arm 80 and a second arm 82, both extending from the body 62. Respective distal end regions 80a, 82a of both arms 80, 82 are adapted to connect the blade unit 30 to the connector 60. The distal end regions 80a, 82a can for example be provided with suitable structures, e.g. shell bearing structures to pivotally connect the blade unit 30 to the connector 60. The body has a recess 64 with an opening 66. The body 62 also has a user-operable latch 68. The latch 68 has a first end 72 and a second end 76. The first end 72 of the latch 68 has a protrusion 70 that extends into the recess 64. The second end 76 of the latch 68 has a lever 74 whereby a user can apply a suitable force F to operate the latch 68. The latch 68 is supported in the body 62 by integrally formed torsion beam springs 90, formed with the latch 68 in a region between the first end 72 and the second end 76.

The connector 60 is preferably manufactured by injection molding. A preferred material is a biopolymer or a mixture of a biopolymer and a particulate plant-based non-polymeric material, e.g. 75% biopolymer/25% plant material. A preferred biopolymer is medium chain polyhydroxyalkanoate (PHA). Medium chain PHA is preferred over short chain PHA for benefits of toughness and resiliency, compared to short chain polymers that can be hard but brittle. The connector 60 can be formed from a polymer that is not a bio-material. This is less preferable for “sustainability” reasons but such a material can provide cromulent performance. Suitable polymers include polyoxymethylene (POM, also known as acetal), polyamide (e.g. PA6 or PA6.6) and acrylonitrile butadiene styrene (ABS), and mixtures of suitable materials.

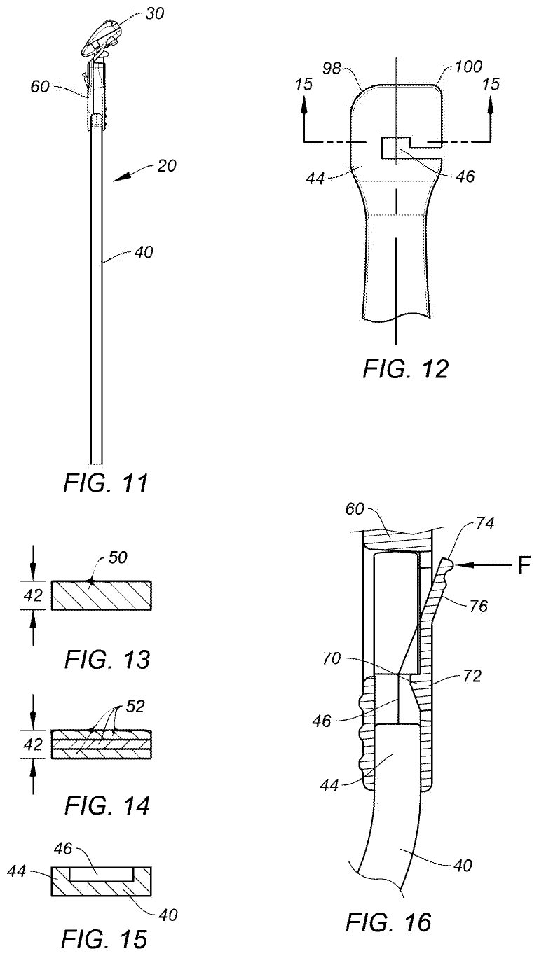

Referring now to FIGS. 8-15, a handle 40 is depicted. The handle 40 is elongated and has a first end 44 and a second end 48. The handle 40 preferably comprises a slat 38, being a single component part. The handle 40 has a thickness 42 that is preferably uniform (see especially FIGS. 13 and 14). The handle 40 preferably has a curved profile when viewed in an orientation perpendicular to the thickness 42 (see FIG. 10). The curved profile can provide ergonomic (haptic) advantages for the user, e.g. presenting the cartridge 30 at an habitual orientation for use relative to the user's habitual grip position. The handle 40 can also be straight (see FIG. 11). The first end 44 has an aperture 46. The aperture 46 preferably extends through the first end 44 but can extend part-way into the first end (see FIG. 15) such that the walls bounding the aperture 46 provide adequate engagement with the protrusion 70 of the connector 60 (see FIG. 16). The aperture 46 is preferably fully bounded (i.e. the bounding walls extend fully around the aperture 46) or can be partially bounded (see FIG. 12).

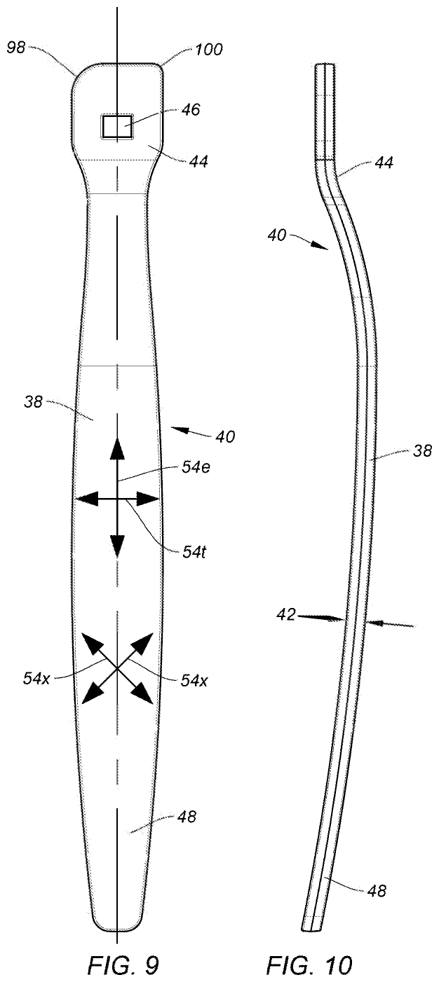

The handle 40 comprises a plant-based non-polymeric material, e.g. a wood-based or a grass-based material, the material defining a fiber direction 54. Another suitable material is a compressed leaf mass, e.g. palm leaves. A preferred material is bamboo (a type of grass). A preferred wood is birch but other woods such as the giant redwood, the larch, the fir and the mighty Scots pine are suitable. The handle 40 preferably comprises a single layer 50 of plant-based non-polymeric material (see FIG. 13). The handle 40 can equally preferably comprise a laminated (e.g. “plywood”) structure of multiple (e.g. 2 to 9 but preferably 3) (sub-)layers 52 (see FIG. 14). (Sub-) layers 52 can be suitably bonded together in processes that will be well known to the skilled worker. In embodiments having multiple (sub-)layers 52, the fiber direction 54 of adjacent layers can be arranged angularly displaced. In FIG. 9 a fiber direction 54e of a layer 52 can be aligned with the length of the handle 40 with a next adjacent layer's fiber direction 54t arranged transversely thereto. A fiber direction 54x can be angled, e.g. at 45 degrees, to the length of the handle 40 with a next adjacent layer's fiber direction 54x opposedly arranged.

The thickness 42 of the handle is preferably 2.7 mm but other thicknesses can be suitable and the present disclosure should not be limited thereto. In one preferred execution the thickness 42 can be provided by a three-layer 52 laminate of bamboo. The central (sub-) layer 52 has a fiber direction 54e aligned with the length of the handle 40 and the (next adjacent) outer layers 52 have fiber directions 54t transverse to the central layer 52. In another preferred execution the handle 40 comprises a single layer 50 of birch, having a fiber direction 54e aligned with the length of the handle 40.

The handle 40 can be manufactured by providing a sheet of plant-based non-polymeric material having a suitable thickness 42 and stamping (perforating) a suitable flat form. In executions having a curved profile, the profile can be provided by suitable heat, or heat and humidity processes (e.g. steam forming). Such processes will be well known to the skilled worker. The handle is preferably flat in transverse cross section (see FIGS. 13-14) but can be non-flat, e.g. having a gentle curve across its transverse width. Such a non-flat transverse shape can be resultant from a process to provide the curved profile.

One purpose of the disclosed safety razor 20 is a semi-disposable razor whereby a single handle 40 can be packaged with a number (e.g. 5) of replacement cartridges (each comprising a blade unit 30 connected to a connector 60) such that a user can selectively replace the cartridge. In embodiments where the handle 40 has a curved profile it is desirable that the user correctly orients the handle 40 relative to the connector 60. To assist avoiding user mistakes, the handle 40 in combination with the connector 60 is provided with a poka-yoke feature 92. Poka-yoke is a Japanese term that is adopted in English language dictionaries, that means “mistake-proofing” or “inadvertent error prevention.” The first end 44 of the handle 40 can be provided with a first outer corner radius 98 and a second outer corner radius 100. The corner radii 98, 100 are sized to be obviously different to a user. For example, the first outer corner radius 98 can be 4.5 mm, having a magnitude three times that of the second outer corner 100 radius that can be 1.5 mm. The end of the recess 64 opposed the opening 66 of the connector 60 is provided with respective complementary first and second inner corner radii 94, 96. To assist user recognition of a correct or incorrect orientation of the first end 44 of the handle 40 in the recess 64 of the connector 60 a wall bounding the recess 64 can be provided with a window opening 88 permitting a user to view the inner corner radii 94, 96 and thus how the outer corner radii 98, 100 are correctly or incorrectly engaging inner corner radii 94, 96. If, for example, a user attempts to insert the first end 44 into the recess in an incorrect orientation, the smaller outer corner radius 96 will contact the larger inner corner radius 94 before the first end 44 is completely inserted in the recess 64. Latch protrusion 70 will not engage aperture 46 and the handle 40 will not be correctly retained in the connector 60. FIG. 16 is a detailed portion of a sectional view of a connector 60 correctly connected to a handle 40, showing latch protrusion 70 engaged in aperture 46. To disconnect the cartridge from the handle 40, a user can apply a suitable force F to the lever 74 at the second end 76 of the latch 68. The latch rotates about torsion beam springs 90 (not seen in this Fig., see e.g. FIG. 4) to disengage protrusion 70 from aperture 46 thus allowing the handle 40 to be withdrawn from the connector 60.

Features of the disclosure include the following:

1. A safety razor (20), comprising: a blade unit (30) having a housing (32) with a razor blade (34); an elongated handle (40) having a uniform thickness (42), preferably 2.7 mm, and having a first end (44) including an aperture (46) extending into the thickness (42), and an opposed second end (48); and a connector (60) having a body (62) with a first arm (80) and a second arm (82) both extending from the body (62), respective distal end regions (80a, 82a) of both arms (80, 82) being adapted to connect the blade unit (30) to the handle (40); the body (62) having a recess (64) having an opening (66), and a user-operable latch (68) including a protrusion (70) at a first end (72) of the latch (68), the protrusion (70) extending into the recess (64), the first end (44) of the handle (40) being removably received in the recess (64) and the protrusion (70) being received in the aperture (46) to secure the connector (60) to the handle (40), and the protrusion (70) being releasable from the aperture (46) by a user-applied force (F) to a lever (74) at a second end (76) of the latch (68) opposite the first end (72) to release the first end (44) of the handle (40) from the recess (64).

2. The safety razor (20) of feature 1, wherein the handle (40) has a curved profile in an orientation perpendicular to the thickness (42).

3. The safety razor (20) of feature 1 or feature 2, wherein the handle (40) is flat in transverse cross section.

4. The safety razor (20) of any preceding feature, wherein the aperture (46) in the first end (44) of the handle (40) is bounded.

5. The safety razor (20) of any preceding feature, wherein the aperture (46) in the first end (44) of the handle (40) extends through the first end (44).

6. The safety razor (20) of any preceding feature, wherein the first end (44) of the handle (40), in combination with the recess (64) of the connector (60) define a poka yoke feature (92) to prevent an incorrect orientation of the handle (40) in the connector (60).

7. The safety razor (20) of feature 6, wherein the poka yoke feature (92) includes a first outer corner radius (98) and a second outer corner radius (100), each outer corner radius (98, 100) being at the first end (44) of the handle (40), and the first outer corner radius (98) is different than the second outer corner radius (100), preferably the first outer corner radius (98) has a magnitude three times the magnitude of the second outer corner radius (100).

8. The safety razor (20) of any preceding feature, wherein the handle (40) comprises a plant-based, non-polymeric material, preferably one of wood-based and grass-based, more preferably bamboo.

9. The safety razor (20) of feature 8, wherein the plant-based, non-polymeric material defines a fiber direction (54).

10. The safety razor (20) of any preceding feature, wherein the handle (40) comprises a single layer (50) of plant-based non-polymeric material.

11. The safety razor (20) of any of feature 1-9, wherein the handle (40) comprises between two and nine layers (52) of plant-based non-polymeric material, preferably three layers (52) of plant-based non-polymeric material.

12. The safety razor (20) of feature 11, wherein the fiber direction (54) of any one layer (52) is arranged at an angle to the fiber direction (54) of the next adjacent layer (52), preferably arranged perpendicularly to the fiber direction (54) of the next adjacent layer (52).

13. The safety razor (20) of any preceding feature, wherein the handle (40) comprises only a single component part.

14. The safety razor (20) of any preceding feature, wherein the user-operable latch (68) is supported in the body (62) by a torsion beam spring (90) integrally formed between the body (62) and the latch (68).

15. The safety razor (20) of any preceding feature, wherein the connector (60) comprises one of a biopolymer, preferably medium chain polyhydroxyalkanoate (PHA), and mixture of medium chain polyhydroxyalkanoate (PHA) and a plant-based non-polymeric material.

16. A connector (60) for a safety razor (20), the connector (60) being adapted to removably connect a handle (40) to a blade unit (30), comprising:

a body (62) with a first arm (80) and a second arm (82) both extending from the body (62), respective distal end regions (80a, 82a) of both arms (80, 82) being adapted to connect the blade unit (30) to the connector (60); the body (62) having a recess (64) having an opening (66), and a user-operable latch (68) including a protrusion (70) at a first end (72) of the latch (68) extending into the recess (64), the recess (64) being adapted to removably receive the first end (44) of the handle (40), and the protrusion (70) being received in an aperture (46) at the first end (44), the protrusion (70) being releasable from the aperture (46) by a user-applied force (F) to a lever (74) at a second end (76) of the latch (68) opposite the first end (72) to release the first end (44) of the handle (40) from the recess (64).

17. The connector (60) of feature 16, wherein the recess (64) of the connector (60) in combination with the first end (44) of the handle (40), define a poka yoke feature (92) to prevent an incorrect orientation of the handle (40) when received in the connector (60).

18. The connector (60) of feature 17, wherein the poka yoke feature (92) includes a first inner corner radius (94) and a second inner corner radius (96), each inner corner radius (94, 96) being at an end of the recess (64) opposed the opening (66), and the first inner corner radius (94) is different than the second inner corner radius (96), preferably the first inner corner radius (94) has a magnitude three times the magnitude of the second inner corner radius (96).

19. The connector (60) of feature 18, wherein a wall bounding the recess (64) has a window opening (88) permitting a user to view the inner corner radii (94, 96).

20. The connector (60) of any of features 16-19, wherein the user-operable latch (68) is supported in the body (62) by a torsion beam spring (90) integrally formed between the body (62) and the latch (68).

21. The connector (60) of feature 20, wherein the user-operable latch (68) includes a second end (76) opposite the first end (72) and having a lever (74), and the torsion beam spring (90) is formed with the latch (68) in a region between the first end (72) and the second end (76).

22. The connector (60) of any of features 16-21, wherein the connector (60) comprises one of a biopolymer, preferably medium chain polyhydroxyalkanoate (PHA), and mixture of medium chain polyhydroxyalkanoate (PHA) and a plant-based non-polymeric material.

23. A handle (40) for a safety razor, comprising:

an elongated slat (38) having a uniform thickness (42), preferably 2.7 mm, and having a first end (44) including an aperture (46) extending into the thickness (42), and an opposed second end (48), comprising a plant-based, non-polymeric material that defines a fiber direction (54), the material being preferably one of wood-based and grass-based, more preferably bamboo.

24. The handle (40) of feature 23, wherein the handle (40) has a curved profile in an orientation perpendicular to the thickness (42).

25. The handle (40) of feature 23 or feature 24, wherein the handle (40) is flat in transverse cross section.

26. The handle (40) of any of features 23-25, wherein the aperture (46) in the first end (44) of the handle (40) is bounded.

27. The handle (40) of any of features 23-26, wherein the aperture (46) in the first end (44) of the handle (40) extends through the first end (44).

28. The handle (40) of any of features 23-27, wherein the first end (44) of the handle (40), in combination with a recess (64) of a connector (60) define a poka yoke feature (92) to prevent an incorrect orientation of the handle (40) in the connector (60).

29. The handle (40) of feature 28, wherein the poka yoke feature (92) includes a first outer corner radius (98) and a second outer corner radius (100), each outer corner radius (98, 100) being at the first end (44) of the handle (40), and the first outer corner radius (98) is different than the second outer corner radius (100), preferably the first outer corner radius (98) has a magnitude three times the magnitude of the second outer corner radius (100).

30. The handle (40) of any of features 23-29, wherein the handle (40) comprises a single layer (50) of plant-based non-polymeric material.

31. The handle (40) of any of features 23-29, wherein the handle (40) comprises between two and nine layers (52) of plant-based non-polymeric material, preferably three layers (52) of plant-based non-polymeric material.

32. The handle (40) of feature 31, wherein the fiber direction (54) of any one layer (52) is arranged at an angle to the fiber direction (54) of the next adjacent layer (52), preferably arranged perpendicularly to the fiber direction (54) of the next adjacent layer (52).

33. The handle (40) of any of features 23-32, wherein the handle (40) comprises only the slat (38), and the slat (38) is a single component part.

While various embodiments have been described above it should be understood that they have been presented by way of example only, and not limitation. For instance, modifications or changes as can be made within the scope of the attached claims and features disclosed in connection with any one embodiment can be used alone or in combination with each feature of the respective other embodiments. Thus, the breadth and scope of any embodiment should not be limited by any of the above described exemplary embodiments but should be defined only in accordance with the following claims and their equivalents.

1. A safety razor, comprising:
a blade unit having a housing with a razor blade;
an elongated handle having a uniform thickness, and having a first end including an aperture extending into the thickness, and an opposed second end; and
a connector having a body with a first arm and a second arm both extending from the body, respective distal end regions of both arms being adapted to connect the blade unit to the handle; the body having a recess having an opening, and a user-operable latch including a protrusion at a first end of the latch, the protrusion extending into the recess, the first end of the handle being removably received in the recess and the protrusion being received in the aperture to secure the connector to the handle, and the protrusion being releasable from the aperture by a user-applied force (F) to a lever at a second end of the latch opposite the first end to release the first end of the handle from the recess.

2. The safety razor of claim 1, wherein the handle has a curved profile in an orientation perpendicular to the thickness.

3. The safety razor of claim 1, wherein the handle is flat in transverse cross section.

4. The safety razor of claim 1, wherein the aperture in the first end of the handle is bounded.

5. The safety razor of claim 1, wherein the aperture in the first end of the handle extends through the first end.

6. The safety razor of claim 1, wherein the first end of the handle, in combination with the recess of the connector define a poka yoke feature to prevent an incorrect orientation of the handle in the connector.

7. The safety razor of claim 6, wherein the poka yoke feature includes a first outer corner radius and a second outer corner radius, each outer corner radius being at the first end of the handle, and the first outer corner radius is different than the second outer corner radius.

8. The safety razor of claim 1, wherein the handle comprises a plant-based, non-polymeric material.

9. The safety razor of claim 8, wherein the plant-based, non-polymeric material defines a fiber direction.

10. The safety razor of claim 1, wherein the handle comprises a single layer of plant-based non-polymeric material.

11. The safety razor of claim 1, wherein the handle comprises between two and nine layers of plant-based non-polymeric material.

12. The safety razor of claim 11, wherein the fiber direction of any one layer is arranged at an angle to the fiber direction of the next adjacent layer.

13. The safety razor of claim 1, wherein the handle comprises only a single component part.

14. The safety razor of claim 1, wherein the user-operable latch is supported in the body by a torsion beam spring integrally formed between the body and the latch.

15. The safety razor of claim 1, wherein the connector comprises one of medium chain polyhydroxyalkanoate (PHA), and mixture of medium chain polyhydroxyalkanoate (PHA) and a plant-based non-polymeric material.

16. A connector for a safety razor, the connector being adapted to removably connect a handle to a blade unit, comprising:
a body with a first arm and a second arm both extending from the body, respective distal end regions of both arms being adapted to connect the blade unit to the connector; the body having a recess having an opening, and a user-operable latch including a protrusion at a first end of the latch extending into the recess, the recess being adapted to removably receive the first end of the handle, and the protrusion being received in an aperture at the first end, the protrusion being releasable from the aperture by a user-applied force (F) to a lever at a second end of the latch opposite the first end to release the first end of the handle from the recess.

17. The connector of claim 16, wherein the recess of the connector in combination with the first end of the handle, define a poka yoke feature to prevent an incorrect orientation of the handle when received in the connector.

18. The connector of claim 17, wherein the poka yoke feature includes a first inner corner radius and a second inner corner radius, each inner corner radius being at an end of the recess opposed the opening, and the first inner corner radius is different than the second inner corner radius.

19. The connector of claim 18, wherein a wall bounding the recess has a window opening permitting a user to view the inner corner radii.

20. The connector of claim 16, wherein the user-operable latch is supported in the body by a torsion beam spring integrally formed between the body and the latch.

21. The connector of claim 20, wherein the user-operable latch includes a second end opposite the first end and having a lever, and the torsion beam spring is formed with the latch in a region between the first end and the second end.

22. The connector of claim 16, wherein the connector comprises one of medium chain polyhydroxyalkanoate (PHA), and mixture of medium chain polyhydroxyalkanoate (PHA) and a plant-based non-polymeric material.

23. A handle for a safety razor, comprising:
an elongated slat having a uniform thickness, and having a first end including an aperture extending into the thickness, and an opposed second end, comprising a plant-based, non-polymeric material that defines a fiber direction.

24. The handle of claim 23, wherein the handle has a curved profile in an orientation perpendicular to the thickness.

25. The handle of claim 23, wherein the handle is flat in transverse cross section.

26. The handle of claim 23, wherein the aperture in the first end of the handle is bounded.

27. The handle of claim 23, wherein the aperture in the first end of the handle extends through the first end.

28. The handle of claim 23, wherein the first end of the handle, in combination with a recess of a connector define a poka yoke feature to prevent an incorrect orientation of the handle in the connector.

29. The handle of claim 28, wherein the poka yoke feature includes a first outer corner radius and a second outer corner radius, each outer corner radius being at the first end of the handle, and the first outer corner radius is different than the second outer corner radius (100).

30. The handle of claim 23, wherein the handle comprises a single layer of plant-based non-polymeric material.

31. The handle of claim 23, wherein the handle comprises between two and nine layers of plant-based non-polymeric material.

32. The handle of claim 31, wherein the fiber direction of any one layer is arranged at an angle to the fiber direction of the next adjacent layer (52).

33. The handle of claim 23, wherein the handle comprises only the slat, and the slat is a single component part.
